(19) United States
(12) Patent Application Publication
(10) Pub. No.: US 2025/0288967 A1
(43) Pub. Date: Sep. 18, 2025

(54) AGITATION APPARATUS AND AGITATION SYSTEM

(71) Applicant: SAKURA RUBBER CO., LTD., Tokyo (JP)

(72) Inventors: Tetsuya Iwasaki, Tokyo (JP); Atsushi Hirayama, Tokyo (JP)

(73) Assignee: SAKURA RUBBER CO., LTD., Tokyo (JP)

(21) Appl. No.: 19/224,035

(22) Filed: May 30, 2025

Related U.S. Application Data
(63) Continuation of application No. PCT/JP2023/020997, filed on Jun. 6, 2023.

(30) Foreign Application Priority Data
Nov. 30, 2022 (JP) 2022-191833

(51) Int. Cl. B01F 33/452; B01F 33/25; B01F 33/501; B01F 35/32

(52) U.S. Cl. CPC B01F 33/452; B01F 33/25; B01F 33/50111; B01F 35/3204

(57) ABSTRACT

An agitation apparatus according to an embodiment is used in a container which contains contents and an agitation tool magnetically attractable to agitate the contents. The agitation apparatus includes a first rotating member which rotates about a first axis. The first rotating member has a first locating surface on or above which the container is placed and a first magnet located away from the first axis. In a state where the container is placed on or above the first locating surface, the agitation tool is rotated about the first axis as the first rotating member rotates about the first axis.

### CROSS-REFERENCE TO RELATED APPLICATIONS

This application is a Continuation Application of PCT Application No. PCT/JP2023/020997, filed Jun. 6, 2023 and based upon and claiming the benefit of priority from prior Japanese Patent Application No. 2022-191833, filed Nov. 30, 2022, the entire contents of all of which are incorporated herein by reference.

### BACKGROUND OF THE INVENTION

### 1. Field of the Invention

The present invention relates to an agitation apparatus and an agitation system.

### 2. Description of the Related Art

Conventionally, a container such as a spray can may be used as a spraying apparatus for spraying paint or the like (for example, JP 2017-221889 A). The container is filled with, for example, contents including a curing retarding agent, a spray agent and the like, and an agitation tool for agitating the contents. Before using the spraying apparatus, the contents of the container need to be agitated. For example, the user holds the spray can in his hand and shakes it in the vertical direction, the horizontal direction and the like to agitate the contents.

If, however, the user's agitation is insufficient, the contents may not be mixed. This may cause variations in the quality of the contents sprayed from the spraying apparatus.

### BRIEF SUMMARY OF THE INVENTION

It is an object of the present invention to provide an agitation apparatus and an agitation system which are capable of achieving satisfactory spraying of contents of a container.

An agitation apparatus according to an embodiment is used in a container which contains contents and an agitation tool magnetically attractable to agitate the contents. The agitation apparatus comprises a first rotating member which rotates about a first axis. The first rotating member has a first locating surface on or above which the container is placed and a first magnet located away from the first axis. In a state where the container is placed on or above the first locating surface, the agitation tool is rotated about the first axis as the first rotating member rotates about the first axis.

The first locating surface may have a shape along a bottom portion of the container. The first locating surface may have a convex shape projecting toward the container. The first locating surface has a concave shape to be recessed away from the container. The first magnet may be a permanent magnet. The first magnet may be an electromagnet.

The first magnet may include a plurality of first magnets arranged in a circumferential direction with the first axis centered. The agitation apparatus may further comprise an input shaft coupled to an output shaft of a rotation driving unit of a driving source and rotating about a second axis and a power transmitting member which transmits rotation of the input shaft to the first rotating member.

The agitation apparatus may further comprise an apparatus main body inside of which the power transmitting member is located and a first output shaft coupled to the first rotating member and rotatably supported by the apparatus main body. The input shaft may have a first end portion which is located outside the apparatus main body and is couplable to the rotation driving unit of the driving source. The first output shaft may have a second end portion which is located outside the apparatus main body and to which the first rotating member is coupled. In a state where the container is fixed is placed on or above the first locating surface, when the input shaft is rotated by the rotation driving unit, the first rotating member and the agitation tools attracted to the first magnet may rotate about the first axis. The power transmitting member may include a gear which rotates together with the input shaft.

The agitation apparatus may further comprise a second rotating member which rotates about a third axis. The second rotating member may have a second locating surface on or above which the container is placed, and a second magnet located away from the third axis, and the power transmitting member may transmit the rotation of the input shaft to the first rotating member and the second rotating member. The agitation apparatus may further comprise a second output shaft coupled to the second rotating member and rotatably supported by the apparatus main body. The second output shaft may have a third end portion which is located outside the apparatus main body and to which the second rotating member is coupled. The power transmitting member may transmit the rotation of the input shaft to the first output shaft and the second output shaft.

An agitation system according to an embodiment comprises the agitation apparatus and an agitation tool attracted to the first magnet and contained in the container together with the contents. The first magnet may be an electromagnet and the agitation tool may be a magnet. The agitation system may further comprise a control unit which changes a polarity of the first magnet.

With the foregoing configuration, an agitation apparatus and an agitation system which are capable of achieving satisfactory spraying of contents of a container can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view of an agitation system according to a first embodiment.

FIG. 2 is a schematic plan view of an agitation apparatus according to the first embodiment.

FIG. 3 is a schematic side view of the agitation apparatus according to the first embodiment.

FIG. 4 is a schematic cross-sectional view of the agitation apparatus taken along line IV-IV shown in FIG. 2.

FIG. 5 is a schematic plan view showing the interior of the apparatus main body of the apparatus shown in FIG. 2.

FIG. 6 is a schematic plan view showing a lid member shown in FIG. 2.

FIG. 7 is a diagram showing the relationship between a first container of a spraying apparatus and a first rotating member of the agitation apparatus.

FIG. 8 is a schematic partial cross-sectional view of an agitation system according to a second embodiment.

FIG. 9 is a schematic cross-sectional view showing another example of the shape applicable to a container body.

### DETAILED DESCRIPTION OF THE INVENTION

Embodiments of the present invention will be described below with reference to the drawings. The disclosure of each of the embodiments is nothing but one example, and a change in matter in the disclosure, which could easily be conceived by a person with ordinary skill in the art without departing from the subject matter of the invention, can be included in the scope of the present invention. In addition, the drawings do not define the interpretation of the present invention though they may show each component more schematically than in the actual aspect in order to clarify the descriptions of the invention.

In each of the drawings, the symbols may be omitted for the same or similar components arranged consecutively. In addition, in the specification and each drawing, components that perform the same or similar function as that described in the preceding drawings may be denoted by the same reference symbols, and their redundant detailed descriptions may be omitted.

In the drawings, X, Y and Z axes which are orthogonal to each other are shown. The direction along the X axis is referred to as a first direction X, the direction along the Y axis is referred to as a second direction Y, and the direction along the Z axis is referred to as a third direction Z. The third direction Z is a direction normal to the plane including the first direction X and the second direction Y.

### First Embodiment

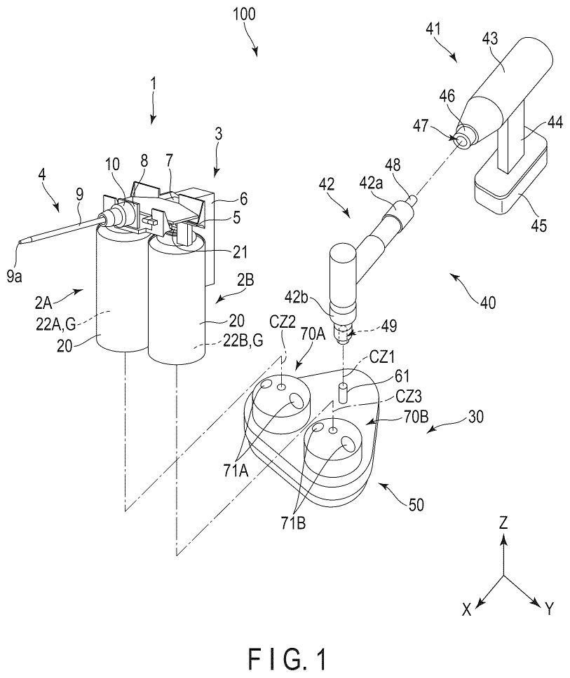

FIG. 1 is a schematic perspective view of an agitation system 100 according to the present embodiment. In this embodiment, the agitation system 100, which is applicable to a two-liquid mixed type spraying apparatus 1, will be described as an example.

The agitation system 100 includes the spraying apparatus 1, an agitation apparatus 30 and a driving unit 40. The spraying apparatus 1 is a two-liquid mixed type spraying apparatus. The spraying apparatus 1 is, in one example, a polyurea spraying apparatus. Polyurea is used, for example, as a lining material in various facilities such as concrete structures and metal tanks.

The spraying apparatus 1 includes a first container 2A, a second container 2B, a holder 3 and a spraying nozzle 4. The first container 2A and second container 2B are, for example, spray cans (aerosol containers). However, the first container 2A and second container 2B may be containers other than the spray cans.

The first container 2A and second container 2B each include a cylindrical container body 20. The top of each container body 20 is provided with a valve 21. The first container 2A contains contents 22A and an agitation tool G, and the second container 2B contains contents 22B and an agitation tool G. The agitation tools G are contained to agitate their respective contents 22A and 22B.

If the valves 21 are opened, the contents 22A and 22B of the first and second containers 2A and 2B are sprayed. Each component of the container body 20 can be formed of a metal material, for example, but may include a member formed of a resin material or the like.

The first and second containers 2A and 2B each contain a polyurea material. Specifically, the first container 2A is filled with, as the contents 22A, a material obtained by adding a curing retarding agent and a spraying agent to an A agent containing isocyanate as a main component.

The isocyanate is preferably an aromatic isocyanate such as 4,4′-diphenylmethane diisocyanate (4,4′-MDI), 2,4-tolylene diisocyanate (2,4-TDI), 2,6-tolylene diisocyanate (2, 6-TDI), etc. Note that the isocyanate may be an aliphatic isocyanate. The A agent may be a mixture obtained as a urethane prepolymer by reacting part of these isocyanates with a polyol. The curing retarding agent is compatible with

the A agent to reduce the viscosity of the agent. An example of the curing retarding agent is methyl ethyl ketone (MEK). Note that the curing retarding agent may be any solvent having excellent compatibility with isocyanate and polyamine, and various general-purpose solvents such as acetone can be used.

As the spraying agent, a liquefied gas spraying agent or a compressed gas spraying agent can be used. Examples of the liquefied gas spraying agent include a liquefied gas spraying agent such as dimethyl ether (DME) and liquefied petroleum gas (LPG). Examples of the spraying agent of the compressed gas system include compressed carbon dioxide gas and nitrogen gas. In the present embodiment, it is preferable to use a liquefied gas spraying agent. Since the liquefied gas spraying agent is a liquid phase in the container, it contributes to the viscosity reduction of the A agent.

The second container 2B is filled with, as the contents 22B, a material obtained by adding a curing retarding agent and a spraying agent similar to those of the first container 2A to the B agent mainly composed of polyamine. The curing retarding agent and liquefied gas spraying agent reduce the viscosity of the B agent.

An example of the blending ratio (volume ratio) of the curing retarding agent and spraying agent to the A agent or B agent is A agent or B agent:methyl ethyl ketone:dimethyl ether (liquid phase)=7:3:10. Preferably, 20 to 40 mL of the curing retarding agent is contained in a total of 100 mL of the A agent (B agent) and the curing retarding agent. If the amount of curing retarding agent is less than 20 mL, the start of the reaction of A agent (B agent) may be accelerated and thus the material may not be sufficiently mixed. If the amount of curing retarding agent exceeds 40 mL, there is a possibility of liquid dripping when the curing retarding agent is applied to a wall or the like. In the case of the liquid phase, the amount of spraying agent is preferably almost the same as the sum of A agent (B agent) and curing retarding agent by volume.

The B agent is a mixture of polyamine with an average molecular weight of 1000 to 10000 and aromatic diamine. As the polyamine, for example, polyalkylene amine such as polyoxypropylenediamine is preferable. Examples of the aromatic diamine include diethyltoluenediamine, 4, 4′-methylenebis (N-sec-butylaniline) or a mixture thereof. The blending ratio of the B agent is, for example, 20 to 40 parts by weight of aromatic diamine to 100 parts by weight of polyamine.

The holder 3 includes a base 5, a grip 6 and a trigger 7. Each part of the holder 3 is formed of, for example, a resin material. The base 5 is detachable from the first and second containers 2A and 2B. The trigger 7 and the grip 6 are attached to the base 5.

The trigger 7 allows the user to operate the valves 21 of the first and second containers 2A and 2B. The trigger 7 is located above the valves 21 of the first and second containers 2A and 2B. The trigger 7 is supported rotatably around a hinge provided at one end of the base 5.

The spraying nozzle 4 includes an adapter 8, a static mixer 9 and a fixture 10. The adapter 8 is attached to the base 5. The adapter 8 is connected to the valves 21 of the first and second containers 2A and 2B through, for example, a tube (not shown). The proximal end of the static mixer 9 is connected to the adapter 8. The static mixer 9 is fixed to the adapter 8 by means of the fixture 10.

The static mixer 9 mixes the A agent of the first container 2A sent through the adapter 8 with the B agent of the second container 2B sent through the adapter 8. A plurality of elements whose rotational directions are alternately switched are arranged in the static mixer 9.

When the user pushes the trigger 7 downward with his or her thumb or the like of the hand grasping the grip 6, the trigger 7 rotates around the hinge. At this time, if the trigger 7 pushes the valves 21 of the first and second containers 2A and 2B downward, these valves 21 are opened at the same. If the valves 21 are opened, the A agent of the first container 2A and the B agent of the second container 2B are supplied to the static mixer 9.

When the A and B agents pass through the static mixer 9, they are agitated and mixed by a plurality of elements to form polyurea. The formed polyurea is sprayed from a spraying hole 9a of the static mixer 9.

The agitation apparatus 30 can be applied to a container (for example, a spray can) including an agitation tool G. The agitation apparatus 30 is configured to rotate the agitation tool G relative to the fixed container. The container may be fixed by the user, by the holder 3, or by other methods. The agitation apparatus 30 includes an apparatus main body 50, an input shaft 61, a first rotating member 70A and a second rotating member 70B. For example, the first rotating member 70A is provided below the first container 2A of the spraying apparatus 1, and the second rotating member 70B is provided below the second container 2B of the spraying apparatus 1.

The input shaft 61 rotates about axis CZ1 (second axis). The axis CZ1 of the input shaft 61 extends along the third direction Z. The input shaft 61 is a solid shaft in the example shown in FIG. 1. Part of the input shaft 61 projects above the apparatus main body 50.

The first rotating member 70A rotates about axis CZ2 (first axis). The axis CZ2 extends along the third direction Z. The axis CZ2 is, for example, parallel to the axis CZ1. The first rotating member 70A includes a plurality of (e.g., two) magnets 71A (first magnets).

The second rotating member 70B rotates about axis CZ3 (third axis). The axis CZ3 extends along the third direction Z. The axis CZ3 is parallel to the axis CZ1 and CZ2, for example. The second rotating member 70B includes a plurality of (e.g., two) magnets 71B (second magnets).

The driving unit 40 includes a driving source and an attachment 42. The driving source is, for example, a power tool 41. The power tool 41 is an electric hand drill in one example, but may be other types of power tools. The power tool 41 includes a main body 43, a grip 44 and a battery 45.

The main body 43 has a rotation driving unit 46 at an end. The rotation driving unit 46 rotates about an axis parallel to the first direction X. The rotation driving unit 46 has an output shaft 47. The output shaft 47 is a hollow shaft in the example shown in FIG. 1. The output shaft 47 rotates about an axis parallel to the first direction X together with the rotation driving unit 46.

The attachment 42 has an L-shape in the example shown in FIG. 1, but is not limited to this example. The attachment 42 includes an input unit 42a having an input shaft 48 and an output unit 42b having an output shaft 49. The input shaft 48 is, for example, a solid shaft. The output shaft 49 is, for example, a hollow shaft.

In the example shown in FIG. 1, the axis of the input shaft 48 of the attachment 42 is parallel to the first direction X, and the axis of the output shaft 49 thereof is parallel to the third direction Z. Thus, the rotation about the axis parallel to the first direction X is converted to rotation about the axis parallel to the third direction Z by the attachment 42.

In the example shown in FIG. 1, the input shaft 48 of the attachment 42 is coupled to the output shaft 47 of the rotation driving unit 46 of the power tool 41, and the output shaft 49 of the attachment 42 is coupled to the input shaft 61 of the agitation apparatus 30. Thus, the input shaft 61 of the agitation apparatus 30 is coupled to the output shaft 47 of the rotation driving unit 46 via the attachment 42, and is rotated by the power tool 41.

Next is a description of the agitation apparatus 30.

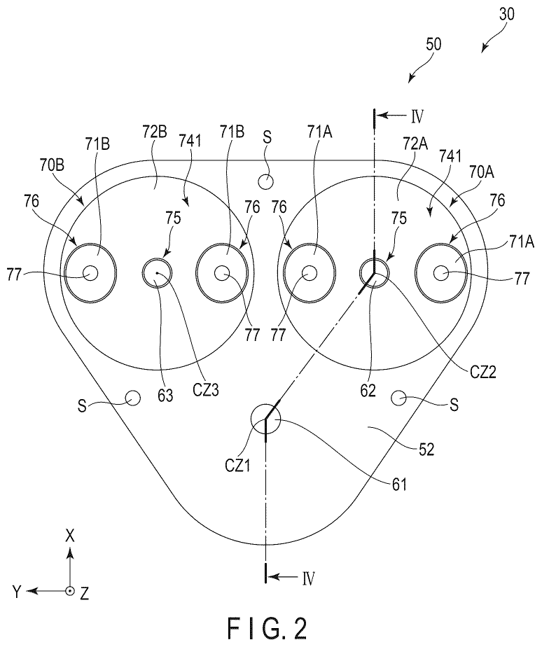

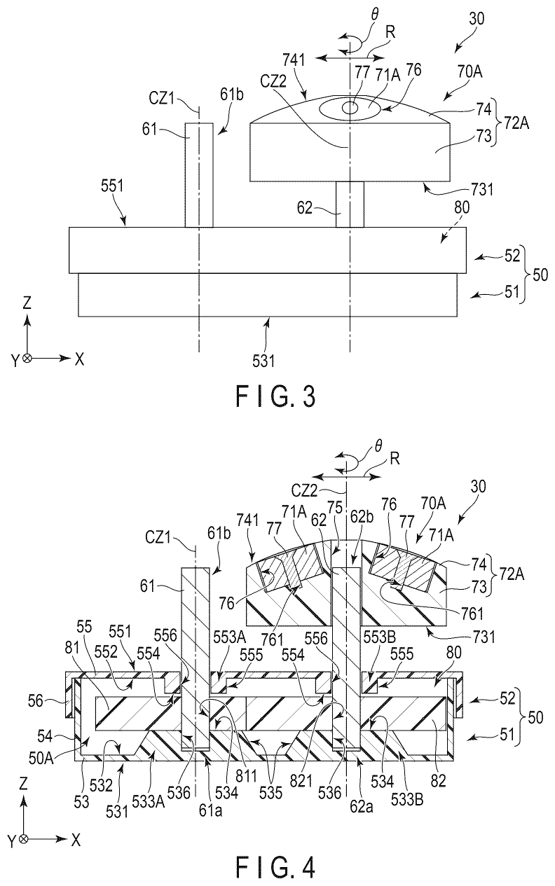

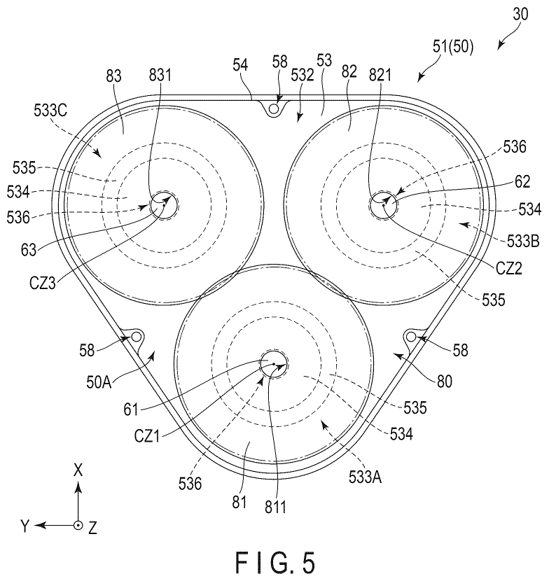

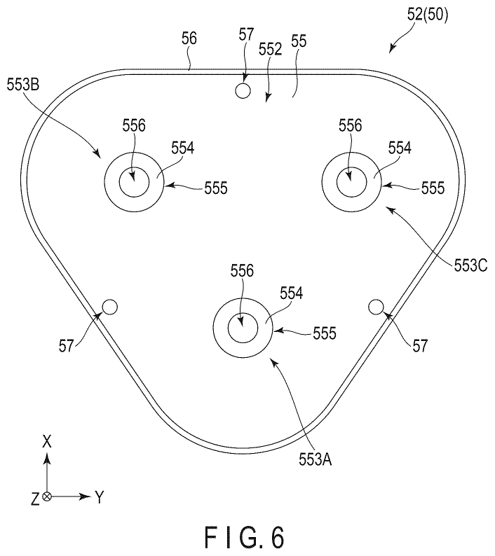

FIG. 2 is a schematic plan view of the agitation apparatus 30 according to the present embodiment. FIG. 3 is a schematic side view of the agitation apparatus 30 according to the present embodiment. FIG. 4 is a schematic cross-sectional view of the agitation apparatus 30 taken along line IV-IV shown in FIG. 2. FIG. 5 is a schematic plan view showing the interior 50A of the apparatus main body 50 shown in FIG. 2. FIG. 6 is a schematic plan view showing a lid member 52 shown in FIG. 2.

In FIGS. 3 and 4, the agitation apparatus 30 is viewed in the second direction Y. In FIG. 5, some members such as the lid member 52 are omitted. In

FIG. 6, the lid member 52 is viewed in the third direction Z.

As described with reference to FIG. 1, the agitation apparatus 30 includes the apparatus main body 50, input shaft 61, first rotating member 70A and second rotating member 70B. As shown in FIGS. 2 to 6, the agitation apparatus 30 further includes output shafts 62 and 63 (first output shaft and second output shaft) and a power transmitting member 80.

Each component of the apparatus main body 50 is formed of a resin material, for example, but may be formed of a metal material and the like. The apparatus main body 50 has a substantially triangular shape when viewed in a direction opposite to the third direction Z. The apparatus main body 50 is not limited to this shape but may have other shapes.

When viewed in the direction opposite to the third direction Z, the axes CZ1, CZ2 and CZ3 are located at the respective vertexes of a triangle (for example, an isosceles triangle). The distance between the axes CZ1 and CZ2 is equal to, for example, the distance between the axes CZ1 and CZ3.

The apparatus main body 50 includes a box member 51 and a lid member 52. As shown in FIGS. 4 and 5, the box member 51 has a bottom wall 53 and a side wall 54 connected to the bottom wall 53. The bottom wall 53 and side wall 54 are integrally formed as one unit, for example, but are not limited to this example. The side wall 54 is provided along the edge of the bottom wall 53. The side wall 54 extends from the bottom wall 53 toward the third direction Z.

The bottom wall 53 has a first surface 531 and a second surface 532 opposite to the first surface 531. The first and second surfaces 531 and 532 are substantially parallel to the X-Y plane defined by the X and Y axes. The second surface 532 is opposed to the lid member 52.

The bottom wall 53 has lower support portions 533A, 533B and 533C. The lower support portions 533A, 533B and 533C have similar shapes. The lower support portions 533A, 533B and 533C have, for example, a substantially truncated cone shape.

The lower support portions 533A, 533B and 533C further include a third surface 534 and a fourth surface 535 connecting the second surface 532 and the third surface 534, and a recess 536. As shown in FIG. 4, the third surface 534 is located above the second surface 532.

The third surface 534 is substantially parallel to the X-Y plane. As shown in FIG. 4, the fourth surface 535 is formed in a tapered shape. The recess 536 is recessed from the third surface 534 toward the first surface 531. The recess 536 has a circular shape when viewed in a direction opposite to the third direction Z.

The lid member 52 is located above the box member 51. As shown in FIGS. 4 and 6, the lid member 52 includes a top wall 55 and a side wall 56 connected to the top wall 55. The top wall 55 and side wall 56 are formed integrally as one unit, for example, but are not limited to this example.

The side wall 56 is provided along the edge of the top wall 55. The side wall 56 extends from the top wall 55 toward a direction opposite to the third direction Z. The sidewall 56 surrounds the sidewall 54 of the box member 51 from outside in the example shown in FIG. 4.

The top wall 55 has a fifth surface 551 and a sixth surface 552 opposite to the fifth surface 551.

The fifth and sixth surfaces 551 and 552 are substantially parallel to the X-Y plane. The sixth surface 552 is opposed to the second surface 532 of the box member 51.

The top wall 55 has upper support portions 553A, 553B and 553 C. The upper support portions 553A, 553B and 553C have similar shapes. The upper support portions 553A, 553B and 553C have a cylindrical shape, for example. The upper support portions 553A, 553B and 553C each have a seventh surface 554, an eighth surface 555 connecting the seventh surface 554 and the sixth surface 552, and a through hole 556.

The seventh surface 554 is located below the sixth surface 552. The seventh surface 554 is substantially parallel to the X-Y plane. The eighth surface 555 extends along the third direction Z. The through hole 556 penetrates the seventh surface 554 and the fifth surface 551. The through hole 556 has, for example, a circular shape when viewed in a direction opposite to the third direction Z.

When the lid member 52 lies on the box member 51, the third surface 534 of the lower support portion 533A is opposed to the seventh surface 554 of the upper support portion 553A, the third surface 534 of the lower support portion 533B is opposed to the seventh surface 554 of the upper support portion 553B, and the third surface 534 of the lower support portion 533C is opposed to the seventh surface 554 of the upper support portion 553C.

The interior 50A of the apparatus main body 50 corresponds to the area surrounded by the bottom wall 53, top wall 55 and side wall 54. The lid member 52 is fixed to the box member 51 by, for example, a plurality of (e.g., three) screws S (shown in FIG. 2). The screws S are inserted through a through hole 57 (shown in FIG. 6) formed in the lid member 52, and fixed to their respective female screws 58 (shown in FIG. 5) formed in the box member 51.

The input shaft 61 and output shafts 62 and 63 are formed of a metallic material such as stainless steel. The input shaft 61 and output shafts 62 and 63 may be formed of a resin material or the like as well as the metal material.

The input shaft 61 and output shafts 62 and 63 have similar shapes, for example. The input shaft 61 and output shafts 62 and 63 have a cylindrical shape, for example, but are not limited to this example. The input shaft 61 and output shafts 62 and 63 are, for example, parallel pins. The lengths of the input shaft 61 and output shafts 62 and 63 are equal, for example. The lengths of the input shaft 61 and output shafts 62 and 63 may be different in other examples.

As shown in FIG. 4, the input shaft 61 is rotatably supported on the apparatus main body 50 by the recess 536 of the lower support portion 533A and the through hole 556 of the upper support portion 553A. The axis of the recess 536 of the lower support portion 533A and the axis of the through hole 556 of the upper support portion 553A are positioned coaxially with the axis CZ1.

The lower end portion 61a of the input shaft 61 is located in the recess 536 of the lower support portion 533A, and the upper end portion 61b of the input shaft 61 is located above the lid member 52. The upper end portion 61b (first end portion) of the input shaft 61 is coupled to the output shaft 49 (shown in FIG. 1) of the attachment 42.

As shown in FIG. 4, the output shaft 62 is rotatably supported on the apparatus main body 50 by the recess 536 of the lower support portion 533B and the through hole 556 of the upper support portion 553B. The axis of the recess 536 of the lower support portion 533B and the axis of the through hole 556 of the upper support portion 553B are positioned coaxially with the axis CZ2 of the first rotating member 70A.

The lower end portion 62a of the output shaft 62 is located in the recess 536 of the lower support portion 533B, and the upper end portion 62b (second end portion) of the output shaft 62 is located above the lid member 52. The upper end portion 62b of the output shaft 62 is coupled to the first rotating member 70A.

As shown in FIG. 2, the output shaft 63 is located adjacent to the output shaft 62 in the Y direction at a distance therebetween. The output shaft 63 is rotatably supported on the apparatus main body 50 by the recess 536 of the lower support portion 533C and the through hole 556 of the upper support portion 553C. The axis of the recess 536 of the lower support portion 533C and the axis of the through hole 556 of the upper support portion 553 C are positioned coaxially with the axis CZ3 of the second rotating member 70B.

The lower end portion of the output shaft 63 is located in the recess 536 of the lower support portion 533C, and the upper end portion (third end portion) of the output shaft 63 is located above the lid member 52. The upper end portion of the output shaft 63 is coupled to the second rotating member 70B.

The shapes of the recesses 536 of the lower support portions 533A, 533B and 533C and the through-holes 556 of the upper support portions 553A, 553B and 553C are appropriately changed in accordance with, for example, the shapes of the input shaft 61 and output shafts 62 and 63.

As shown in FIG. 3, the first rotating member 70A is provided above the apparatus main body 50. More specifically, the first rotating member 70A is provided in the third direction Z at a distance from the lid member 52.

As shown in FIG. 2, the first rotating member 70A includes two magnets 71A and a first rotating member body 72A. The first rotating member body 72A may be formed of, for example, a resin material. The first rotating member body 72A may be formed of a metallic material.

The first rotating member body 72A extends along the third direction Z. As shown in FIGS. 2 to 4, the first rotating member body 72A includes a lower portion 73, an upper portion 74 connected to the lower portion 73, an output shaft mounting hole 75 and two magnet fixing portions 76.

The first rotating member body 72A is integrally formed, for example. The lower portion 73 has, for example, a cylindrical shape. The upper portion 74 has a dome shape whose diameter decreases along the third direction Z, for example. As another example, the upper portion 74 may have a hemispherical shape or a truncated cone shape.

The lower portion 73 has a lower surface 731, and the upper portion 74 has an upper surface 741 (a first locating surface). The lower surface 731 is opposed to the fifth surface 551 of the lid member 52.

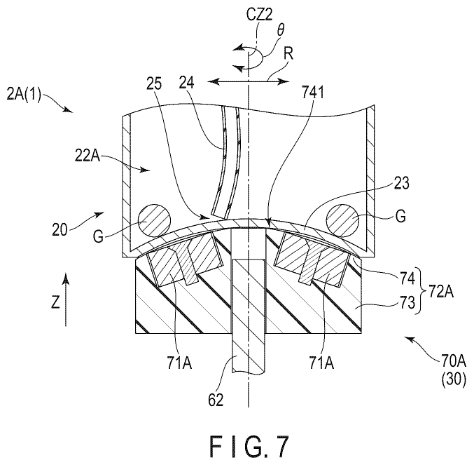

The first container 2A is placed on the upper surface 741. The upper surface 741 is opposed to the bottom wall 23 (shown in FIG. 7) of the container main body 20 of the first container 2A.

The lower surface 731 is substantially parallel to the X-Y plane. The upper surface 741 has a convex shape projecting in the third direction Z, for example. The upper surface 741 has a curved shape in the example shown in FIG. 3.

The upper end portion 62b of the output shaft 62 is inserted through the output shaft mounting hole 75 along the third direction Z, and the output shaft 62 is mounted thereon. In the example shown in FIG. 4, the output shaft mounting hole 75 is a through hole penetrating the lower surface 731 and the upper surface 741.

The output shaft mounting hole 75 has a circular shape when viewed in a direction opposite to the third direction Z. The shape of the output shaft mounting hole 75 is appropriately changed in accordance with the shape of the output shaft 62. The output shaft mounting hole 75 may not penetrate to the upper surface 741.

The two magnets 71A are provided in the two magnet fixing portions 76. The two magnet fixing portions 76 are formed at positions apart from the axis CZ2 in the radial direction R (shown in FIG. 4) with the axis CZ2 centered. In other words, the two magnets 71A are located away from the axis CZ2 in the first rotating member 70A.

The two magnet fixing portions 76 are, for example, separated by 180 degrees in the circumferential direction θ (shown in FIG. 4) with the axis CZ2 centered. In other words, the two magnets 71A are located in the circumferential direction θ with the axis CZ2 centered. The number of magnet fixing portions 76 is changed appropriately in accordance with the number of magnets 71A. The magnet fixing portions 76 are recessed portions recessed from the upper surface 741.

In the example shown in FIG. 4, the axes of the two magnet fixing portions 76 are inclined with respect to the axis CZ2. In other words, the axes of the two magnet fixing portions 76 intersect the axis CZ2. The magnet fixing portions 76 each have a cylindrical shape. The shape of each of the magnet fixing portions 76 is changed appropriately in accordance with the shape of the magnets 71A.

The two magnets 71A are fixed by, for example, screws 77 in the two magnet fixing portions 76. Female screws 761 (shown in FIG. 4) for fixing the screws 77 may be formed at the bottoms of the two magnet fixing portions 76.

The two magnets 71A are, for example, permanent magnets. The permanent magnet is a neodymium magnet in one example, but is not limited to this example. Each of the magnets 71A may be formed of one magnet or a plurality of magnets. Each of the magnets 71A is formed, for example, by laying a plurality of magnets.

The two magnets 71A may have S poles or N poles on their sides facing the container body 20. The two magnets 71A may, for example, direct the same poles toward the container body 20. As another example, one of the two magnets 71A may direct its S pole toward the container body 20, and the other of the two magnets 71A may direct its N pole toward the container body 20.

The second rotating member 70B is provided above the apparatus main body 50. More specifically, the second rotating member 70B is provided in the third direction Z at a distance from the lid member 52. The second rotating member 70B includes two magnets 71B and a second rotating member body 72B. The second rotating member body 72B is formed in the same manner as the first rotating member body 72A.

That is, the second rotating member body 72B has a lower portion 73, an upper portion 74 connected to the lower portion 73, an output shaft mounting hole 75 and two magnet fixing portions 76. The upper surface 741 of the upper portion 74 of the second rotating member 70B corresponds to a second locating surface.

The second container 2B is placed on the upper surface 741 of the second rotating member 70B. The upper surface 741 of the second rotating member 70B faces the bottom wall of the container body 20 of the second container 2B. The output shaft 63 is attached to the output shaft mounting hole 75 of the second rotating member 70B.

The two magnets 71B are provided on the two magnet fixing portions 76 of the second rotating member 70B. The two magnet fixing portions 76 of the second rotating member 70B are formed at positions apart from the axis CZ3 in the radial direction with the axis CZ3 centered. In other words, the two magnets 71B are located away from the axis CZ3 in the second rotating member 70B.

The two magnet fixing portions 76 of the second rotating member 70B are, for example, separated from each other by 180 degrees in the circumferential direction with the axis CZ3 centered. The two magnets 71B are formed in the same manner as the two magnets 71A.

The power transmitting member 80 transmits the rotation of the input shaft 61 to the output shafts 62 and 63. As shown in FIGS. 4 and 5, the power transmitting member 80 includes a first gear 81, a second gear 82 and a third gear 83.

The first, second and third gears 81, 82 and 83 are formed of, for example, a resin material. The first, second and third gears 81, 82 and 83 are, for example, spur gears. The first, second and third gears 81, 82 and 83 have similar shapes, for example. The teeth of the first, second and third gears 81, 82 and 83 are parallel to the third direction Z.

The first gear 81 is provided on the input shaft 61. More specifically, the input shaft 61 is inserted through a mounting hole 811 formed in the central part of the first gear 81. The first gear 81 is fixed to the input shaft 61 between the third surface 534 of the lower support portion 533A and the seventh surface 554 of the upper support portion 553A in the interior 50A of the apparatus main body 50.

For example, the first gear 81 is in contact with the third surface 534 of the lower support portion 533A, and a gap is formed between the first gear 81 and the seventh surface 554 of the upper support portion 553A. A gap may be formed between the first gear 81 and the third surface 534 of the lower support portion 533A. As the input shaft 61 rotates, the first gear 81 rotates about the axis CZ1.

The second gear 82 is provided on the output shaft 62. More specifically, the output shaft 62 is inserted through a mounting hole 821 formed in the central part of the second gear 82. The second gear 82 is fixed to the output shaft 62 between the third surface 534 of the lower support portion 533B and the seventh surface 554 of the upper support portion 553B in the interior 50A of the apparatus main body 50.

For example, the second gear 82 is in contact with the third surface 534 of the lower support portion 533B, and a gap is formed between the second gear 82 and the seventh surface 554 of the upper support portion 553B. A gap may be formed between the second gear 82 and the third surface 534 of the lower support portion 533B. The second gear 82 rotates about the axis CZ2. The second gear 82 engages with the first gear 81.

The third gear 83 is provided on the output shaft 63. More specifically, the output shaft 63 is inserted through a mounting hole 831 formed in the central part of the third gear 83. The third gear 83 is fixed to the output shaft 63 between the third surface 534 of the lower support portion 533C and the seventh surface 554 of the upper support portion 553C in the interior 50A of the apparatus main body 50.

For example, the third gear 83 is in contact with the third surface 534 of the lower support portion 533C, and a gap is formed between the third gear 83 and the seventh surface 554 of the upper support portion 553C. A gap may be formed between the third gear 83 and the third surface 534 of the lower support portion 533C. The third gear 83 rotates about the axis CZ3. The third gear 83 engages with the first gear 81, not with the second gear 82.

As shown in FIG. 5, the first gear 81 engages with each of the second and third gears 82 and 83. Thus, as the input shaft 61 and the first gear 81 rotate, the second and third gears 82 and 83 rotate. As the second gear 82 rotates, the output shaft 62 rotates, and as the third gear 83 rotates, the output shaft 63 rotates.

As a result, the first rotating member 70A provided on the output shaft 62 rotates, and the second rotating member 70B provided on the output shaft 63 rotates. In this manner, the power transmitting member 80 transmits the rotation of the input shaft 61 to the first rotating member 70A and the second rotating member 70B.

The output shafts 62 and 63 rotate in a direction opposite to the input shaft 61. The number of rotations per unit time of the output shafts 62 and 63 is equal to, for example, the number of rotations per unit time of the input shaft 61. The number of rotations per unit time of the output shafts 62 and 63 may be adjusted to differ from, for example, the number of rotations per unit time of the input shaft 61. Although the first gear 81 engages with the second and third gears 82 and 83, this combination of these first to third gears 81, 82 and 83 is not limited to this example.

Next is a description of the relationship between the first and second containers 2A and 2B of the spraying apparatus 1 and the first and second rotating members 70A and 70B of the agitation apparatus 30.

FIG. 7 is a diagram showing the relationship between the first container 2A of the spraying apparatus 1 and the first rotating member 70A of the agitation apparatus 30. FIG. 7 shows a cross section of each component. As shown in FIG. 7, the first container 2A is located on the first rotating member 70A from above. The axis of the container body 20 is positioned coaxially with the axis CZ2.

The bottom wall 23 is provided at the lower end of the container body 20. The bottom wall 23 has, for example, a convex shape toward the interior of the container body 20 (upper part in FIG. 7). The bottom wall 23 has a curved shape in one example. Thus, a dome-shaped space whose diameter decreases along the third direction Z is formed below the bottom wall 23.

As described with reference to FIG. 1, the container body 20 contains the contents 22A and the agitation tool G. For example, a plurality of agitation tools G are contained therein. In the example shown in FIG. 7, the number of agitation tools G is two, but may be one or three or more.

The agitation tools G are attracted to the magnets. In one example, the agitation tools G are formed of a ferromagnetic material such as an iron material, but this is not limited to this example. As another example, the agitation tools G may be magnets. The outer peripheral surfaces of the agitation tools G may be subjected to a treatment such as nickel plating. The specific gravity of the agitation tools G is larger than that of the material constituting the content 22A contained in the container body 20. The agitation tools G do not float with respect to the contents 22A but are located on the bottom wall 23.

In one example, the agitation tools G each have a spherical shape. The diameter of each of the agitation tools G is, for example, about 5 mm to 15 mm. As another example, the agitation tools G may have a substantially elongated spherical shape, a polyhedral shape, or a shape other than these shapes.

As still another example, the agitation tools G may have a projection for the purpose of improving the agitation effect. As the shape of the projection, various shapes such as a blade can be applied. As yet another example, the agitation tools G may have a recess on the outer peripheral surface.

In the example shown in FIG. 7, the agitation tools G are attracted to the magnets 71A across the bottom wall 23. When the first rotating member 70A rotates about the axis CZ2 with the first container 2A placed on the upper surface 741, the agitation tools G rotate about the axis CZ2 together with the magnets 71A. Using the agitation apparatus 30, the contents 22A can mechanically agitated.

At this time, the two magnets 71A and the two agitation tools G are separated from the axis CZ2 in the radial direction R. In other words, the two magnets 71A or the two agitation tools G do not overlap the axis CZ2 in the third direction Z.

The first rotating member body 72A has a shape corresponding to the shape of the bottom portion of the container body 20. The bottom portion includes the bottom wall 23 of the container body 20 and its nearby portion (e.g., side wall).

The upper surface 741 of the upper portion 74 has a shape along the bottom portion of the container body 20. More specifically, the upper surface 741 has a convex shape projecting toward the bottom wall 23 of the container body 20. The upper surface 741 in one example has a curvature equal to that of the bottom wall 23 of the container body 20.

Therefore, at least part of the upper portion 74 of the first rotating member body 72A can be located in a space formed below the bottom wall 23. Thus, the distance between the two magnets 71A of the first rotating member 70A and the agitation tools G can be reduced. As a result, the agitation tools G are easily attracted to the magnets 71A. The distance between the two magnets 71A and the agitation tools G is preferably as small as possible.

In the example shown in FIG. 7, a gap is formed between the bottom wall 23 of the container body 20 and upper surface 741, but this gap need not be formed. In other words, the upper surface 741 may be in contact with the bottom wall 23 of the container body 20. In this case, the upper surface 741 may be in contact with the entire surface or part of the bottom wall 23 of the container body 20.

With reference to FIG. 7, the relationship between the first container 2A and the first rotating member 70A of the agitation apparatus 30 has been described. The same applies to the relationship between the second container 2B and the second rotating member 70B of the agitation apparatus 30.

That is, the container body 20 of the second container 2B contains the contents 22B and the two agitation tools G. The agitation tools G of the second container 2B are attracted to the magnets 71B. In other words, as the magnets 71B rotate about the axis CZ3, the agitation tools G of the second container 2B also rotate about the axis CZ3. The contents 22B can be mechanically agitated using the agitation apparatus 30.

Next is a description of a method of using the agitation apparatus 30 and the agitation system 100 according to the present embodiment.

First, the first and second containers 2A and 2B of the spraying apparatus 1 are located on the agitation apparatus 30. The first and second containers 2A and 2B are each attached to the holder 3, for example. More specifically, the first container 2A is located on the upper surface 741 of the first rotating member 70A, and the second container 2B is located on the upper surface 741 of the second rotating member 70B. The contents 22A and the two agitation tools G are contained in the first container 2A, and the contents 22B and the two agitation tools G are contained in the second container 2B.

The first and second rotating members 70A and 70B are rotated while the first and second containers 2A and 2B are located on the agitation apparatus 30. More specifically, the input shaft 61 is rotated by the power tool 41 (shown in FIG. 1).

Thus, the output shaft 62 and the first rotating member 70A rotate about the axis CZ2 via the power transmitting member 80, and the output shaft 63 and the second rotating member 70B rotate about the axis CZ3.

The first rotating member 70A includes two magnets 71A, and the second rotating member 70B includes two magnets 71B. Thus, the two magnets 71A rotate about the axis CZ2, and the two magnets 71B rotate about the axis CZ3.

Since each of the agitation tools G is attracted to the magnets, the two agitation tools G of the first container 2A are attracted to the two magnets 71A, and the two agitation tools G of the second container 2B are attracted to the two magnets 71B.

Thus, as the two magnets 71A rotate about the axis CZ2, the two agitation tools G of the first container 2A also rotate about the axis CZ2. Similarly, as the two magnets 71B rotate about the axis CZ3, the two agitation tools G of the second container 2B also rotate about the axis CZ3.

As the two agitation tools G rotate about the axis CZ2 at the interior of the container body 20 of the first container 2A, the contents 22A are agitated by the agitation tools G. As the two agitation tools G of the second container 2B rotate about the axis CZ3 at the interior of the container body 20, the contents 22B are agitated by the agitation tools G.

After the contents 22A of the first container 2A and the contents 22B of the second container 2B are agitated by the agitation apparatus 30, the spraying apparatus 1 may be detached from the agitation apparatus 30 and the first and second containers 2A and 2B may be shaken vertically.

The contents 22A and 22B contain a plurality of materials having different specific gravities. If the first and second containers 2A and 2B are shaken vertically after the agitation apparatus 30 is used, the materials having different specific gravities can be mixed. Since the first and second containers 2A and 2B are attached to the holder 3, the second container 2B can be shaken vertically together with the first container 2A.

After that, the distal end of the static mixer 9 (shown in FIG. 1) is directed to a work place or a work for coating with polyurea, and the trigger 7 is pressed. At this time, the A and B agents are agitated and mixed in the static mixer 9, and the polyurea is sprayed from the spraying hole 9a.

As an example, the user uses the agitation apparatus 30 that is placed on the ground, floor or the like. As another example, the user can use the agitation apparatus 30 that is held by hand. In addition, the user can spray polyurea while performing an agitating operation by the agitation apparatus 30 in which the first and second containers 2A and 2B are placed.

The agitation apparatus 30 configured as described above includes the first rotating member 70A that rotates about the axis CZ2. The first rotating member 70A has the upper surface 741 on which the container body 20 of the first container 2A is placed, and the magnets 71A located away from the axis CZ2.

If the first container 2A is placed on the first rotating member 70A, the agitation tools G are separated from the axis CZ2 and attracted to the magnets 71A. As the first rotating member 70A rotates about the axis CZ2 in this state, the agitation tools G attracted to the magnets 71A rotate about the axis CZ2. Thus, the content 22A are agitated by the agitation tools G.

The content 22A may contain pigments, resin components and the like. Since the pigments and resin components have a high specific gravity among the materials constituting the content 22A, they may precipitate or aggregate on the bottom wall 23 and thus become precipitates.

If the agitation tools G rotate about the axis CZ2, the pigments and resin components are dispersed in the contents 22A. In other words, if the pigments and resin components are agitated by the agitation tools G, they float from the bottom wall 23. Since, furthermore, the agitation tools G rotate while being in contact with the bottom wall 23, it is easy to disperse precipitates and agglomeration caused by the pigments and resin components on the bottom wall 23.

The first container 2A includes, for example, a tube 24 (shown in FIG. 7). The tube 24 extends from above the container body 20 toward the bottom wall 23. The tube 24 corresponds to a flow path through which the contents 22A pass when the valves 21 (shown in FIG. 1) are opened.

An inlet hole 25 (shown in FIG. 7) is provided at one end of the tube 24. The portion of the tube 24 including the inlet hole 25 is immersed in the liquid phase of the contents 22A. In the example shown in FIG. 7, the inlet hole 25 is located near the bottom wall 23. The inflow hole 25 is opened toward the bottom wall 23, for example.

The pigments and resin components may cause the inlet hole 25 to clog and block the inlet hole 25 partially or completely. Using the agitation apparatus 30, the contents 22A can be mechanically agitated.

Thus, the pigments and resin components can be dispersed in the contents 22A. As a result, the pigments and resin components are hardly precipitated or aggregated near the bottom wall 23, so that clogging of the inflow hole 25 is suppressed.

If the pigments and resin components are precipitated or aggregated near the bottom wall 23, they are difficult to disperse only by shaking the first container 2A vertically by the user. If, therefore, the contents 22A are mechanically agitated by the agitation apparatus 30, the pigments and resin components can be dispersed in the contents 22A.

If the user shakes the first container 2A vertically after the contents 22A are agitated by the agitation apparatus 30, variations caused when the pigments and resin components are mixed with a plurality of materials can be suppressed.

In other words, the agitating operation performed by the agitation apparatus 30 is an auxiliary operation prior to the operation of shaking the first container 2A vertically by the user. As a result, the present embodiment can the agitation apparatus 30 capable of achieving satisfactory spraying of the contents 22A of the first container 2A.

In the present embodiment, the agitation apparatus 30 further includes the second rotating member 70B which rotates about the axis CZ3. The second rotating member 70B has the upper surface 741 on which the container body 20 of the second container 2B is placed, and the magnets 71B located away from the axis CZ3. Thus, like the contents of the first container 2A, the contents 22B of the second container 2B can be mechanically agitated.

That is, the use of the agitation apparatus 30 makes it possible to disperse the pigments and resin components in the contents 22A and 22B. Thus, the pigments and resin components are hardly precipitated or aggregated near the bottom wall 23, so that clogging of the inflow hole 25 is suppressed in the first and second containers 2A and 2B.

Since the contents 22A and 22B contain a plurality of materials having different specific gravities, a difference in concentration may occur between the upper part and the lower part of the container body 20. This can be an obstacle to uniform working.

In particular, in the case of spraying a two-liquid resin, if the mixing ratio of the two liquids to be reacted does not reach a desired one, there is a concern that the sprayed resin may not react due to an excess of either the main agent or the curing agent when chemically reacting, or may not be sufficiently cured as a polymer material.

In the present embodiment, by agitating the contents 22A and 22B by the agitation apparatus 30, it is possible to suppress variations caused when the pigments and resin components are mixed with a plurality of materials.

As a result, the mixing ratio of the A agent in the first container 2A and the B agent in the second container 2B can be kept normal for a two-liquid mixing type spraying apparatus 1. The spraying apparatus can thus spray polyurea having desired characteristics.

With the agitation apparatus 30 according to the present embodiment, the user can spray polyurea while performing an agitating operation using the agitation apparatus 30. The user was able to agitate the contents by shaking a container such as a spray can by hand before working, but it was difficult for the user to continue the agitating operation even during spraying.

For example, as an agitation apparatus of a spray can according to a comparative example, there is an apparatus for shaking the spray can or giving vibration to the spray can. Such an agitation apparatus was based on an agitating operation prior to working, and the agitating operation could not be carried out during the working because the apparatus itself was large.

If, therefore, the contents contain materials with different specific gravities or minute additives, there may be a difference in the composition of the contents to be sprayed between the starting point of the working and the ending point thereof. This may cause the finished coating film to become uneven or cause a failure in hardening due to the occurrence of unreacted portions in the chemical reaction.

With the present embodiment, the polyurea can be sprayed while the agitating operation is carried out. Thus, the composition of the sprayed contents hardly vary between the starting point of the working and the ending point thereof. As a result, a satisfactory coating film can be formed in the agitation apparatus 30.

In the present embodiment, a plurality of magnets 71A and 71B are provided in the circumferential direction with the axes CZ2 and CZ3 centered. Thus, the agitation tools G are easily attracted to the magnets 71A and 71B. As a result, when the magnets 71A and 71B rotate, the agitation tools G can be more reliably rotated.

In the present embodiment, the agitation apparatus 30 includes the input shaft 61 and power transmitting member 80. The input shaft 61 is coupled to the output shaft 47 of the rotation driving unit 46 of the power tool 41 via the attachment 42. Using the power tool 41 as a driving source, the agitating device 30 can easily perform its agitating operation.

The coupling of the power tool 41 and the input shaft 61 via the attachment 42 can prevent the spraying apparatus 1 and the power tool 41 from interfering with each other. In addition, the use of a power hand drill as the power tool 41 allows the agitation apparatus 30 to be used at a desired place.

In the present embodiment, the power transmitting member 80 transmits the rotation of the input shaft 61 to the first and second rotating members 70A and 70B. Thus, the first and second containers 2A and 2B can be agitated simultaneously by rotating the input shaft 61. As a result, the agitating operation can be performed efficiently.

As shown in FIG. 1, the agitation apparatus 30 according to the present embodiment can be applied to the first and second containers 2A and 2B while they are attached to the holder 3. The first and second containers 2A and 2B need not be detached from the holder 3 for the agitation. The agitating operation can thus be performed more efficiently.

Since the contents 22A and 22B are mechanically agitated by the agitation apparatus 30, the agitation time, the number of rotations, and the like can be determined in advance. It is thus possible to prevent the agitating operation from varying according to a difference in user. In other words, the agitation apparatus 30 facilitates the control of quality of the contents to be sprayed.

As described above, the present embodiment can provide the agitation apparatus 30 and the agitation system 100 which can achieve satisfactory spraying of the contents of the container. In addition to the above-described functions, various favorable functions can be obtained from the present embodiment.

### Second Embodiment

Next is a description of a second embodiment. The same components as those in the first embodiment are denoted by the same reference numerals, and their descriptions will be omitted as appropriate.

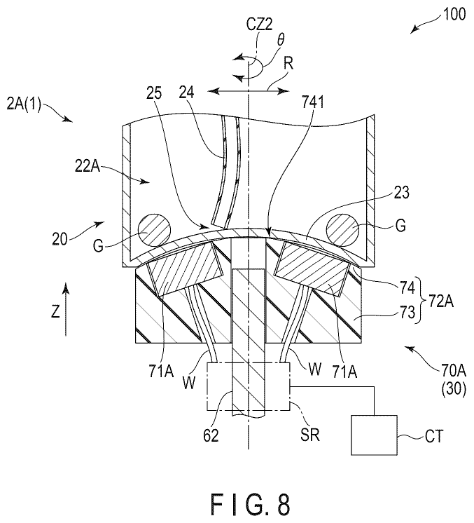

FIG. 8 is a schematic partial cross-sectional view of an agitation system 100 according to the present embodiment. Although a first rotating member 70A will be described with reference to FIG. 8, a second rotating member 70B has a similar configuration. The agitation system 100 of the present embodiment is different from that of the first embodiment in that it includes a control unit CT and magnets 71A and 71B which are electromagnets.

The two magnets 71A are electromagnets. The magnets 71A each have, for example, a cylindrical shape. Wiring W is connected to the two magnets 71A. The agitation system 100 further includes a control unit CT. The control unit CT can adjust the current supplied to the magnets 71A. The control unit CT may include a power supply to supply current to the two magnets 71A.

The wiring W is electrically connected to the control unit CT through, for example, a slip ring mechanism SR provided on the output shaft 62. The control unit CT may be provided in the apparatus main body 50 or may be located in a position other than the apparatus main body 50. The control unit CT may also be connected to the two magnets 71B.

The wiring W is electrically connected to the terminal of the slip ring mechanism SR. The slip ring mechanism SR includes, for example, a slip ring and a brush. Since the control unit CT is connected to the wiring W via the slip ring mechanism SR, current can be supplied to the two magnets 71A without breaking the wiring W.

The agitation tools G are, for example, permanent magnets. As in the first embodiment, the agitation tools G may have a spherical shape or another shape.

The configuration of the present embodiment can bring advantages similar to those of the first embodiment. Furthermore, in the present embodiment, the magnets 71A are electromagnets, and the current supplied to the magnets 71A can be controlled by the control unit CT. Since the current supplied to the magnets 71A is controlled by the control unit CT, the polarities of the magnets 71A, the magnitude of the magnetic force applied from the magnets 71A to the agitation tools G, and the like can be controlled.

For example, if the direction of the current is changed by the control unit CT, the polarity from the magnets 71A toward the container body 20 can be switched between the S pole and the N pole. The control unit CT switches the polarity acting on the agitation tools G at a fixed time interval, for example. The control unit CT can control the magnetic force applied to the agitation tools G by the magnets 71A, for example, by adjusting the magnitude of the current.

Thus, the control unit CT can control the movement of the agitation tools G that are permanent magnets. In one example, the control unit CT can move the agitation tools G irregularly. In another example, the control unit CT can stop the agitation tools G from moving in the interior of the container body 20 by stopping current from being supplied to the magnets 71A.

In still another example, the agitation tools G can be moved to jump up in the container body 20 by changing the current supplied to the magnets 71A by the control unit CT. If the agitation tools G are moved in a desired manner, more advantageous agitation effects can be obtained in the agitation system 100.

Note that in the present embodiment, a spraying apparatus that sprays polyurea is described as an example of the spraying apparatus 1. However, the configuration disclosed in the present embodiment can also be applied to a spraying apparatus that sprays other kinds of materials. In this case, the first and second containers 2A and 2B contain contents suitable to obtain the materials to be sprayed.

The number of containers (spray cans) of the spraying apparatus is not limited to two, but may be one and three or more. In accordance with the number of containers, for example, the shapes of the holder 3 and agitation apparatus 30 are changed as appropriate.

In each of the embodiments described above, an example of the container body 20 of the first and second containers 2A and 2B has been disclosed, but the container body 20 may have other shapes.

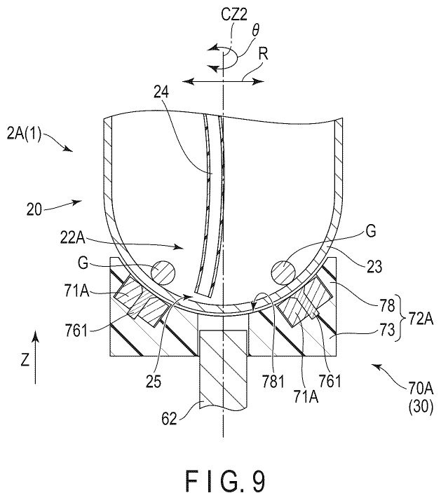

FIG. 9 is a schematic cross-sectional view showing another example of a shape applicable to the container body 20. In the example shown in FIG. 9, the bottom wall 23 of the container body 20 has a hemispherical shape projecting in a direction opposite to the third direction Z.

The first rotating member body 72A includes a lower portion 73 and an upper portion 78 connected to the lower portion 73. The upper portion 78 has an upper surface 781. In the present embodiment, the upper surface 781 corresponds to the first locating surface. The first container 2A is placed on the upper surface 781.

In the example shown in FIG. 9, the upper surface 781 of the upper portion 78 has a shape along the bottom portion of the container body 20. More specifically, the upper surface 781 has a concave shape recessed away from the container body 20. In other words, the upper surface 781 has a shape to wrap the bottom wall 23 of the container body 20.

Even though the container body 20 has a shape as shown in FIG. 9, the distance between the two magnets 71A and the agitation tools G contained in the container body 20 can be decreased if the upper surface 781 has a shape along the bottom portion of the container body 20. In other words, the magnets 71A can be rotated at positions very close to the agitation tools G. As a result, the agitation tools G can reliably be operated by the magnets 71A.

The shape of the first rotating member body 72A as described above can also be applied to the shape of the second rotating member body 72B. The shape of the container body 20 shown in FIG. 9 is an example, and the container body 20 may have other shapes.

The bottom portion of the container body 20 may have, for example, a dome shape whose diameter decreases along a direction opposite to the third direction Z. The bottom portion of the container body 20 may have a substantially semi-elliptical shape. In accordance with the shape of the container body 20, the shapes of the first and second rotating member bodies 72A and 72B are changed as appropriate.

In the present embodiment, part of the input shaft 61 projects above the apparatus main body 50, but may project below the apparatus main body 50. In the present embodiment, the power tool 41 is described as an example of the driving source, but tools other than the power tool 41 may be used.

As the driving source, for example, a motor and a battery electrically connected to the motor can be used. The motor and battery may be, for example, provided above or below the apparatus main body 50. The portability of the agitation apparatus 30 is maintained even though the driving source is configured by a motor and a battery.

In the present embodiment, as an example, the power transmitting member 80 includes a first gear 81, a second gear 82 and a third gear 83, but the power transmitting member 80 may include other members.

The power transmitting member 80 may include, for example, pulleys provided on the input shaft 61 and output shafts 62 and 63, and belts for transmitting rotation of the pulley provided on the input shaft 61 to the pulleys provided on the output shafts 62 and 63.

In the present embodiment, the input shaft 61 is a solid shaft, but may be a hollow shaft. The input shaft 61 is coupled to the power tool 41 via the attachment 42, but may be directly coupled to the power tool 41.

In the present embodiment, the output shaft 47 of the power tool 41 is a hollow shaft, but may be a solid shaft. In accordance with the shapes of the output shaft 47 and input shaft 61, the shapes of the input shaft 48 and output shaft 49 of the attachment 42 are changed as appropriate.

In the present embodiment, the magnets 71A and 71B are exposed toward the first and second containers 2A and 2B, but may not be exposed. Other members may be located between the magnets 71A and 71B and the first and second containers 2A and 2B.

In order to prevent the first and second containers 2A and from rotating together with the first and second rotating members 70A and 70B when the agitation apparatus 30 is used, the first and second containers 2A and 2B may be fixed by a band or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An agitation apparatus used in a container which contains contents and an agitation tool magnetically attractable to agitate the contents, the apparatus comprising:
a first rotating member which rotates about a first axis, wherein:
the first rotating member has a first locating surface on or above which the container is placed and a first magnet located away from the first axis; and
in a state where the container is placed on or above the first locating surface, the agitation tool is rotated about the first axis as the first rotating member rotates about the first axis.

2. The agitation apparatus of claim 1, wherein the first locating surface has a shape along a bottom portion of the container.

3. The agitation apparatus of claim 2, wherein the first locating surface has a convex shape projecting toward the container.

4. The agitation apparatus of claim 2, wherein the first locating surface has a concave shape to be recessed away from the container.

5. The agitation apparatus of claim 1, wherein the first magnet is a permanent magnet.

6. The agitation apparatus of claim 1, wherein the first magnet is an electromagnet.

7. The agitation apparatus of claim 1, wherein the first magnet includes a plurality of first magnets arranged in a circumferential direction with the first axis centered.

8. The agitation apparatus of claim 1, further comprising:
an input shaft coupled to an output shaft of a rotation driving unit of a driving source and rotating about a second axis; and
a power transmitting member which transmits rotation of the input shaft to the first rotating member.

9. The agitation apparatus of claim 8, further comprising:
an apparatus main body inside of which the power transmitting member is located; and
a first output shaft coupled to the first rotating member and rotatably supported by the apparatus main body,
wherein:
the input shaft has a first end portion which is located outside the apparatus main body and is couplable to the rotation driving unit of the driving source;
the first output shaft has a second end portion which is located outside the apparatus main body and to which the first rotating member is coupled;
in a state where the container is fixed is placed on or above the first locating surface, when the input shaft is rotated by the rotation driving unit, the first rotating member and the agitation tools attracted to the first magnet rotate about the first axis.

10. The agitation apparatus of claim 9, wherein the power transmitting member includes a gear which rotates together with the input shaft.

11. The agitation apparatus of claim 9, further comprising a second rotating member which rotates about a third axis,
wherein:
the second rotating member has a second locating surface on or above which the container is placed and a second magnet located away from the third axis; and
the power transmitting member transmits the rotation of the input shaft to the first rotating member and the second rotating member.

12. The agitation apparatus of claim 11, further comprising a second output shaft coupled to the second rotating member and rotatably supported by the apparatus main body,
wherein:
the second output shaft has a third end portion which is located outside the apparatus main body and to which the second rotating member is coupled; and
the power transmitting member transmits the rotation of the input shaft to the first output shaft and the second output shaft.

13. An agitation system comprising:
the agitation apparatus recited in claim 1; and
an agitation tool attracted to the first magnet and contained in the container together with the contents.

14. The agitation system of claim 13, wherein:
the first magnet is an electromagnet; and
the agitation tool is a magnet.

15. The agitation system of claim 14, further comprising a control unit which changes a polarity of the first magnet.
